(19) United States
(12) Patent Application Publication
(10) Pub. No.: US 2009/0195501 A1
(43) Pub. Date: Aug. 6, 2009

(54) HANDHELD POINTING DEVICE, POINTING METHOD THEREOF AND METHOD FOR IMPROVING STATIC DRIFT

(76) Inventors: Chin-Chung Kuo, Taipei (TW); Yeuh-Sheng Ho, Taipei (TW)

Correspondence Address: Muncy, Geissler, Olds & Lowe, PLLC, P.O. BOX 1364, FAIRFAX, VA, 22038-1364, US

(21) Appl. No.: 12/332,120

(22) Filed: Dec. 10, 2008

(30) Foreign Application Priority Data
Feb. 5, 2008 (TW) 097104468

(51) Int. Cl. G09G 5/08

(52) U.S. Cl. 345/157

(57) ABSTRACT

The invention discloses a handheld pointing device, a pointing method thereof and method for improving static drift. The handheld pointing device includes a first piezoelectric vibrating gyro element, a second piezoelectric vibrating gyro element and a processing unit. The processing unit is coupled to the first and second piezoelectric vibrating gyro element, respectively. The piezoelectric vibrating gyro elements are used to detect the rotation of the handheld pointing device and produce a first rotation output and a second rotation output. The processing unit is used to produce a pointing signal via the first rotation output and the second rotation output.

### CROSS REFERENCE TO RELATED APPLICATIONS

This Non-provisional application claims priority under 35 U.S.C. §119(a) on Patent Application No(s). 097104468 filed in Taiwan, Republic of China on Feb. 5, 2008, the entire contents of which are hereby incorporated by reference.

### BACKGROUND OF THE INVENTION

1. Field of Invention

The invention relates to a handheld pointing device and, more particularly, to a handheld pointing device and the pointing method thereof.

2. Related Art

In the past, a pointing device of an image processing device, such as a mouse of a computer, has to be put on an auxiliary flat surface (such as a table top) when it is used, and it needs to be connected to the computer via a cable. Therefore, a user has to stay at a same place when using the pointing device, and he or she further cannot control the position of a cursor by instinctive gestures.

In recent years, the handheld pointing device is developed. A user does not need to stay at a place when he or she controls the movement of the cursor on a computer screen. However, a sensor of the handheld pointing device is usually a combination of two accelerometers, a combination of an accelerometer and a mechanical gyro, a combination of an accelerometer and a capacitance sensing microelectromechanical gyro or a combination of an accelerometer and an optical fiber gyro.

For example, a handheld pointing device using two accelerometers as a sensor uses accelerometers to sense the angles between two axes and the gravity axis. Output signals of the accelerometers are processed to be control signals, and the control signals are wirelessly transmitted to an image processing device such as a computer. However, when operating, the user has to lean to control the movement of the cursor on the screen, which does not meet the demand for the ergonomics. Moreover, the mechanic gyro has a big volume, and therefore it is unfit to be a sensor of the handheld pointing device. The optical fiber gyro also has no competitive strength for its big volume and high price.

### SUMMARY OF THE INVENTION

The invention provides a handheld pointing device, a pointing method thereof and a method for improving static drift to improve the conventional technology.

According to an embodiment, in the invention, the handheld pointing device includes a first piezoelectric vibrating gyro element, a second piezoelectric vibrating gyro element and a processing unit. The first piezoelectric vibrating gyro element is used to determine the rotation of the handheld pointing device in a first direction and produce a first rotation output. The second piezoelectric vibrating gyro element is used to determine the rotation of the handheld pointing device in a second direction and produce a second rotation output. The processing unit is coupled to the first and second piezoelectric vibrating gyro element produces a pointing output according to the first rotation output and the second rotation output. When the handheld pointing device is used, the processing unit updates a static reference voltage of the first piezoelectric vibrating gyro element via the first rotation output.

According to an embodiment, in the invention, the pointing method of the handheld pointing device includes the following steps. The rotation of the handheld pointing device in the first direction and the second direction through the piezoelectric vibrating gyro element is determined. Then, the first rotation output and the second rotation output are produced. A static reference voltage of the piezoelectric vibrating gyro element in the first direction is updated via the first rotation output, and the pointing output is outputted via the first rotation output and the second output.

According to an embodiment, in the invention, the method for the handheld pointing device to improve its static drift includes the following steps. A present rotation output is calculated via the rotation output provided by the piezoelectric vibrating gyro element. Whether to update the maximum rotation value and the minimum rotation value is determined according to the present rotation value. Whether the handheld pointing device is in a static state is determined. If the handheld pointing device is in the static state for more than a preset time, a static reference voltage of the piezoelectric vibrating gyro element is updated via the present rotation value.

According to a preferable embodiment of the invention, when the handheld pointing device is used, the processing unit updates a static reference voltage of the second piezoelectric vibrating gyro element via the second rotation output.

According to a preferable embodiment of the invention, the first piezoelectric vibrating gyro element includes a quartz, a driving circuit and a detecting circuit. The driving circuit is coupled to the quartz to drive the quartz to vibrate. The detecting circuit is coupled to the quartz to detect the vibration of the quartz to produce the first rotation output.

According to a preferable embodiment of the invention, the first piezoelectric vibrating gyro element is coupled to a low pass filter, and the low pass filter is coupled to an amplifier which is coupled to the processing unit.

According to a preferable embodiment of the invention, the step of updating the static reference voltage further includes the following steps. The present rotation value is calculated via the first rotation output. Whether to update the maximum rotation value and the minimum rotation value is determined according to the present value. Whether the handheld pointing device is in the static state is determined. If the handheld pointing device remains in the static state for more than a preset time, the static reference voltage is updated via the present rotation value.

According to a preferable embodiment of the invention, the static reference voltage stored in the memory unit is updated via the first rotation output.

According to a preferable embodiment of the invention, if the present rotation value is greater than the maximum rotation value, the maximum rotation value is updated via the present rotation value.

According to a preferable embodiment of the invention, if the present rotation value is less than the minimum rotation value, the minimum rotation value is updated via the present rotation value.

According to a preferable embodiment of the invention, whether the handheld pointing device is in the static state is determined according to whether the maximum rotation value minus the minimum rotation value leaves a value less than a preset peak to peak value.

In the invention, the piezoelectric vibrating gyro element is used to be a sensor of the handheld pointing device. Therefore, the pointing device is minified to be capable of being held by a hand, and a user may control the cursor on the screen of an image processing device by instinctive gestures. Thus, the user can operate the device in the operation mode which meets the demand for the ergonomics. Moreover, to ensure the more accurate pointing capability of the piezoelectric vibrating gyro element, in the embodiment of the invention, the static reference voltage is updated to solve the problem of static drift.

These and other features, aspects and advantages of the present invention will become better understood with regard to the following description, appended claims, and accompanying drawings.

### BRIEF DESCRIPTION OF THE DRAWINGS

FIG. 1 is a functional block diagram of a handheld pointing device in the first embodiment of the invention;

FIG. 2 is a schematic diagram showing a pointing input system in the first embodiment of the invention;

FIG. 3 is a functional block diagram of a sensing unit of a piezoelectric vibrating gyro element in the first embodiment of the invention;

FIG. 4A is a sectional diagram showing one of sensing units of a piezoelectric vibrating gyro element in the first embodiment of the invention;

FIG. 4B is a top view of the quartz in FIG. 4A;

FIG. 5 is a block diagram of a handheld pointing device in another embodiment of the invention;

FIG. 6 is a schematic diagram showing the static drift produced by the gyro; and

FIG. 7 is a flow chart showing a method for updating the static reference voltage of a piezoelectric vibrating gyro element according to an embodiment of the invention.

### DETAILED DESCRIPTION OF THE INVENTION

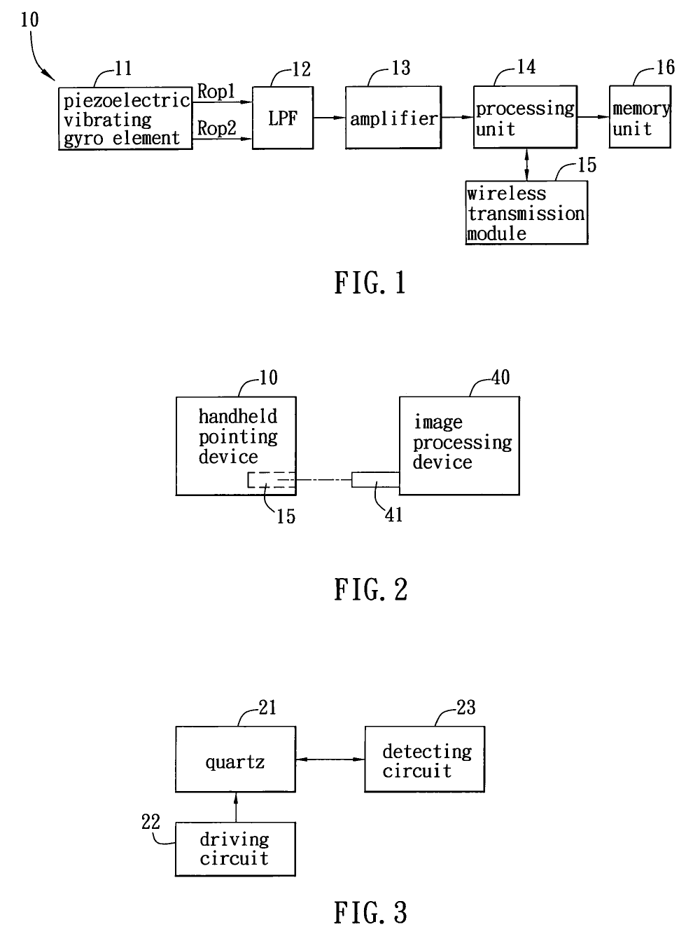

FIG. 1 is a block diagram of a handheld pointing device in a first embodiment of the invention. In the embodiment, the handheld pointing device 10 includes a piezoelectric vibrating gyro element 11, a low pass filter (LPF) 12, an amplifier 13, a processing unit 14, a wireless transmission module 15 and a memory unit 16. The piezoelectric vibrating gyro element 11 is coupled to the low pass filter 12. The low pass filter 12 is coupled to the amplifier 13. The amplifier 13 is coupled to the processing unit 14. The wireless transmission module 15 is coupled to the processing unit 14, and the memory unit 16 is coupled to the processing unit 14. In the embodiment, the piezoelectric vibrating gyro element 11 is coupled to the low pass filter 12 first, and then the low pass filter 12 is coupled to the amplifier 13. In other embodiments, the piezoelectric vibrating gyro element 11 also can be coupled to the amplifier 13 first, and then the amplifier 13 is coupled to the low pass filter 12.

The low pass filter 12 is used to perform a low pass filtering process on an output signal of the piezoelectric vibrating gyro element 11. The amplifier 13 is used to amplify a received signal. The processing unit 14 in the embodiment further includes an analog-digital converter (not shown) to convert the signal processed by the amplifier 13 from analog to digital. The wireless transmission module 15 is used to receive a pointing output of the processing unit 14 and transmit the pointing output to a receiving terminal via a wireless network. The memory unit 16 is used to store a reference voltage and interrelated operational data of the handheld pointing device.

FIG. 2 is a schematic diagram showing a pointing input system of the embodiment. In FIG. 2, the handheld pointing device 10 transmits the pointing output produced by the handheld pointing device 10 to the receiving terminal 41 of the image processing device 40 through the wireless transmission module 15. In the embodiment, the receiving terminal 41 is coupled to the image processing device 40 through a universal serial bus (USB) interface. In addition, the image processing device 40 includes a display unit (not shown). Therefore, the pointing output provided by the handheld pointing device 10 can be converted to a position pointing signal by the image processing device 40, and the handheld pointing device 10 can control the image processing device 40. In the embodiment, the image processing device 40 is a notebook. In other embodiments, the image processing device may be a desktop computer, a digital television or an audio and video entertainment system.

According to FIG. 1, in the embodiment, the piezoelectric vibrating gyro element 11 is a multi-axis gyro, and it is used to sense the rotation of the handheld pointing device 10 in two directions and provide the first rotation output (Rop 1) and the second rotation output (Rop 2) for the low pass filter 12. In the embodiment, in the piezoelectric vibrating gyro element 11, two sensing units are packaged in a chip, and each sensing unit is used to sense the rotation of the handheld pointing device 10 in one direction and to provide a rotation output.

FIG. 3 is a block diagram showing one of the sensing units in the piezoelectric vibrating gyro element. In the embodiment, the sensing unit 20 includes a quartz 21, a driving circuit 22 and a detecting circuit 23. The driving circuit 22 is coupled to the quartz 21 and used to drive the quartz 21 to vibrate. The detecting circuit 23 is also coupled to the quartz 21 and used to detect the vibration of the quartz 21 and produce a rotation output (such as the first rotation output).

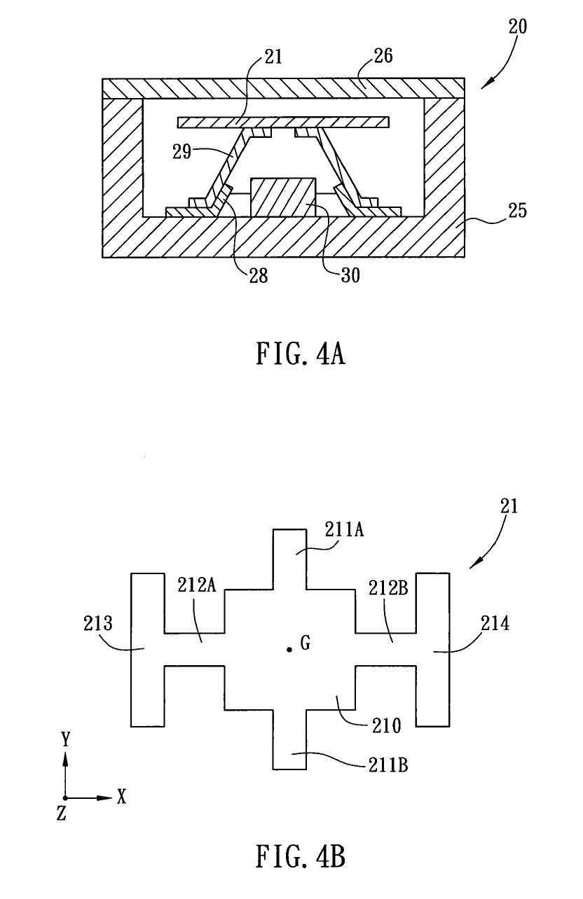

FIG. 4A is a sectional diagram showing one of the sensing units of the piezoelectric vibrating gyro element in the embodiment. As shown in FIG. 3 and FIG 4A, the sensing unit includes a container 25, a lid 26, the quartz 21, a supporter 28, a wiring plate 29 and an integrated circuit 30. In the embodiment, the integrated circuit 30 is disposed facedown at the bottom of the container 25. The integrate circuit 30 includes the driving circuit 22 and the detecting circuit 23.

The central portion of the sensing unit 20 is supported by the wiring plate 29 and the wiring plate 29 is fixed on the supporting plate 28 disposed at the bottom of the container 25. The top of the container 25 is sealed by the lid 26 to keep the inside environment of the container vacuum.

FIG. 4B is a top view of the quartz 21 in FIG. 4A. In the embodiment, the quartz 21 has a structure of double-T. The quartz has an x axis which is called the electric axis, a y axis which is called the mechanical axis and a z axis which is called the optical axis. Moreover, the quartz 21 has a regulated thickness which is formed in the x-y plane.

The quartz 21 has a base 210, vibration detecting arms 211A and 211B, connecting arms 212A and 212B, and vibration driving arms 213 and 214. The vibration detecting arms 211A and 211B extend towards up and down from the base 210, respectively. The connecting arms 212A and 212B extend towards left and right from the base 210, respectively. One end of the connecting arm 212A is connected to the base 210, and the other end of the connecting arm 212A is connected to the vibration driving arm 213. One end of the connecting arm 212B is connected to the base 210, and the other end of the connecting arm 212B is connected to the vibration driving arm 214. Moreover, the vibration driving arm 213 is parallel with the vibration detecting arms 211A and 211B and the vibration driving 214. The vibration driving arms 213 and 214 and the connecting arms 212A and 212B are symmetrical about the y axis of the center of gravity G of the quartz 21.

Output electrodes (not shown) are formed at the surface of the vibration detecting arms 211A and 211B. Driving electrodes are in the surface of the vibration driving arms 213 and 214. Thus, a vibration detecting system for detecting an angular velocity is formed with the connecting arms 212A and 212B, and a vibration driving system for driving the quartz 21 is formed with the connecting arms 212A, 212B and the vibration driving arms 213, 214. Therefore, when the handheld pointing device 20 is rotated, the vibration detecting system detects the angular velocity of the handheld pointing device 20 rotating around the z axis. The angular velocity is then converted to become a rotation output proportional to the angular velocity. Afterwards, the rotation output passes the low pass filter 12 and the amplifier 13, and then it is sent to the processing unit to be processed.

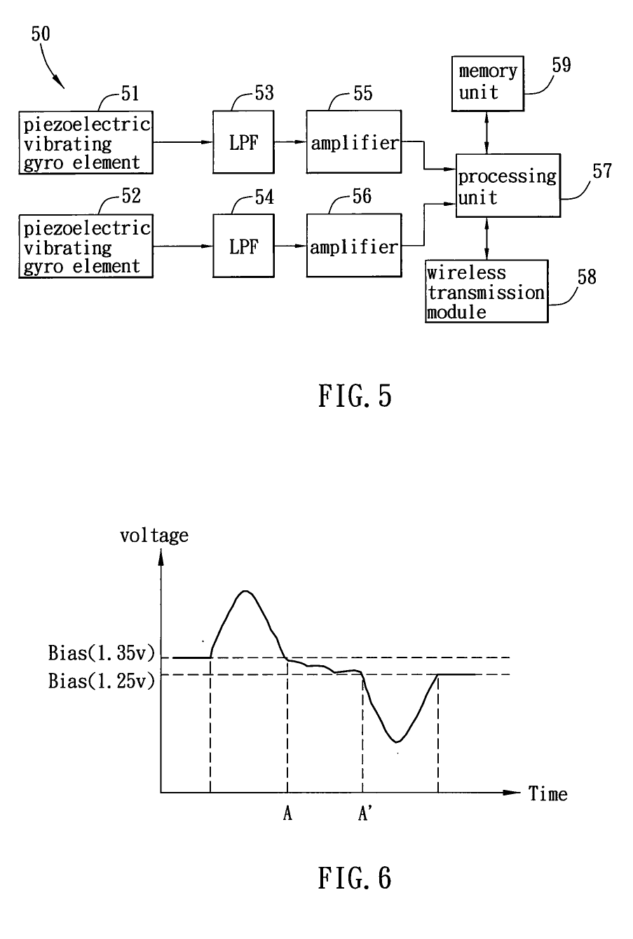

FIG. 5 is a block diagram showing a handheld pointing device in another embodiment of the invention. The handheld pointing device 50 in the embodiment includes piezoelectric vibrating gyro elements 51 and 52, low pass filters 53 and 54, amplifiers 55 and 56, a processing unit 57, a wireless transmission module 58 and a memory unit 59. The piezoelectric vibrating gyro element 51 is coupled to the low pass filter 53. The low pass filter 53 is coupled to the amplifier 55, and the amplifier 55 is coupled to the processing unit 57. The piezoelectric vibrating gyro element 52 is coupled to the low pass filter 54. The low pass filter 54 is coupled to the amplifier 56, and the amplifier 56 is coupled to the processing unit 57. The wireless transmission module 58 is coupled to the processing unit 57, and the memory unit 59 is coupled to the processing unit 57. In this embodiment, the functions of the elements in the handheld pointing device 50 are similar to the functions of the elements in the embodiment above. The piezoelectric vibrating gyro element 51 is a piezoelectric vibrating gyro element with a single axis in this embodiment, and the piezoelectric vibrating gyro element 52 is a piezoelectric vibrating gyro element with a single axis in this embodiment.

Generally, if a conventional handheld pointing device uses a gyro as a space pointing sensor, the center reference voltage (the static reference voltage) outputted by the gyro sensor produces static drift along with the change of the time, operating process or temperature. As shown in A-A′ interval in FIG. 6, the static drift makes the operation scope for the handheld pointing device to point an image processing device drift gradually, and this makes the handheld pointing device fail to control the operation of the image process device accurately. Therefore, in one embodiment of the invention, the handheld pointing device provided by a preferable embodiment of the invention updates the static reference voltage via the rotation output of the piezoelectric vibrating gyro element when a handheld pointing device in a preferable embodiment is used.

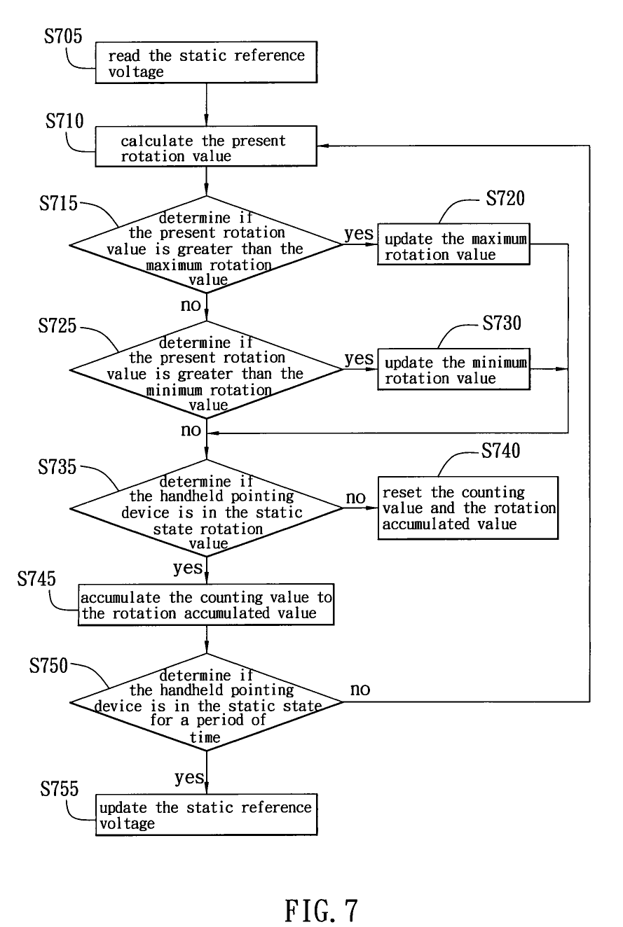

FIG. 7 is a flow chart showing a method for updating the static reference voltage of a piezoelectric vibrating gyro element in an embodiment of the invention. The static reference voltage is, for example, a static reference voltage value W0 of a piezoelectric vibrating gyro element 51. In the embodiment, the piezoelectric vibrating gyro element 51 is used to sense the rotation of the handheld pointing device 50 in the x axis. As shown in FIG. 5 and FIG. 7, in the embodiment, a processing unit 57 determines whether the static reference voltage W0 of the piezoelectric vibrating gyro element 51 needs to be updated every time interval T.

In step S705, when the handheld pointing device 50 is powered on, the processing unit 57 reads the static reference voltage value W0 of the piezoelectric vibrating gyro element 51 from the memory unit 59.

In step S710, when the processing unit 57 receives a first rotation output produced by the piezoelectric vibrating gyro element 51, the processing unit 57 determines a present rotation value of the present handheld pointing device 50 according to the value resulting from the first rotation output minus the static reference voltage read from the memory unit 59. For example, if the first rotation output is 1.9V, and the static reference voltage read from the memory unit is 1V, the present rotation value is 0.9V. Therefore, the processing unit 57 determines that the handheld pointing device 50 rotates upward along the x axis. That is, the handheld pointing device 50 points upward. If the first rotation output is 0.1V, and the static reference voltage read from the memory unit 59 is 1V, the present rotation value is −0.9V. Therefore, the processing unit 57 can determine that the handheld pointing device 50 rotates downward along the x axis. That is, the handheld pointing device 50 points downward.

In step S715, the processing unit 57 further determines whether the present rotation value is greater than the maximum rotation value (W_max) during the time of calculating the static drift. If the present rotation value is greater than the maximum rotation value during the time of calculating the static drift, the maximum rotation value during the time of calculating the static drift is updated via the present rotation value (as shown in step S720). If the rotation value is not greater than the maximum rotation value during the time of calculating the static drift, step S725 is performed.

For example, if the present rotation value is 0.9V, the maximum rotation value during the time of calculating the static drift (the previous maximum rotation value) is 0V, the maximum rotation value (0V) during the time of calculating the static drift is updated to the present rotation value (0.9V), as shown in step S720.

In step S725, the processing unit 57 further determines whether the present rotation value is less than the minimum rotation value (W_min) during the time of calculating the static drift. If the rotation value is less than the minimum rotation value during the time of calculating the static drift, the minimum rotation value is updated via the present rotation value, as shown in step S730. If the present rotation value is not less than the minimum rotation value during the time of calculating the static drift, step S735 is performed. Therefore, in the embodiment, the maximum and minimum rotation value during the time of calculating the static drift may be updated all the time.

For example, if the present rotation value is −0.8V and the minimum rotation value (the previous minimum rotation value) stored in the memory unit 59 is −0.9V, step S735 is performed.

In this embodiment, step S715 is performed first and step S725 is performed next. In other embodiment, step S725 may be performed first and step S715 may be performed next.

In step S735, the processing unit 57 is used to determine whether the handheld pointing device 50 is in a static state. In the embodiment, the processing unit 57 obtains a present peak to peak value resulting from the maximum rotation value during the time of calculating the static drift minus the minimum rotation value during the time of calculating the static drift. Then, the processing unit 57 determines whether the peak to peak value is less than a preset peak to peak value which is a preset value in a counting unit. If the present peak to peak value is less than the preset peak to peak value, it means that the handheld pointing device 50 is almost in the static state. Step S745 is performed. For example, the handheld pointing device 50 is put on the table or held by a user without moving. If the present peak to peak value is greater than the preset peak to peak value, it means that the handheld pointing device 50 is being used by the user, and the handheld pointing device 50 may be rotated by the user greatly. Then, step S740 is performed.

In step S740, the processing unit 57 resets a counter (not shown) inside the processing unit 57 and a rotation accumulated value. In step S745, the handheld pointing device 50 is in the static state, and therefore, the processing unit 57 accumulates the count value, (that is, to perform the counter++), and the present rotation value (W_cur) is added to the rotation accumulated value (W_sum=W_sum+W_cur). For example, when the present counting value is zero, and the rotation accumulated value is zero, the processing unit 57 adds one to the counting value and accumulates the present rotation value (such as 0.9V). Then, the rotation accumulated value is 0.9V. If step S745 is performed the next time, the accumulated value is accumulated again.

In step S750, the processing unit 57 determines whether the handheld pointing device 50 is in the static state for a period of time. In the embodiment, the processing unit 57 determines whether the handheld pointing device 50 is in the static state for a period of time by using a preset counting value. The preset counting value is used to identify the time of calculating the static drift. That is, in the embodiment, the preset count value stands for the preset time relatively. If the count value showing that the handheld pointing device remains in the static state for a certain time is greater than the preset count value, the static reference voltage of the piezoelectric vibrating gyro element 51 is updated. For example, after the processing unit 57 performs step S745, the processing unit 57 determines whether the counting value of the counter is greater than the preset counting value. If not, the processing unit 57 performs step 710. If the processing unit 57 determines the present counting value of the counter is greater than the preset value, it means that the handheld pointing device 50 is in the static state for a period of time, and the piezoelectric vibrating gyro element 51 produces static drift. Therefore, the processing unit 57 performs step S755 to update the static reference voltage in the memory unit 59.

In step S755, in the embodiment, the new static reference voltage is calculated by the processing unit 57 according to the following equation:

Wstatic=Wsum/N+Wstatic_org,

wherein Wstatic stands for a new static reference voltage, Wsum stands for the rotation accumulated value, N stands for the preset counting value and Wstatic_org stands for the static reference voltage stored in a memory value 59 of the handheld pointing device.

For example, if the static reference voltage stored in the memory unit 59 is 1V, the rotation accumulated value is 1.6 V, and the preset value is 80, then the new static reference voltage is 1.2V. Therefore, if the first rotation output of the piezoelectric vibrating gyro element 51 is received to be 1.2V by the processing unit 57, the present rotation value in step 610 is calculated to be 0V by the processing unit 57. Then, the processing unit 57 performs step S715 and S725, the maximum rotation value and minimum rotation value are not updated. Afterward, the processing unit 57 performs step S740. Therefore, to the piezoelectric vibrating gyro element 51, the static drift of the static reference voltage is improved. The handheld pointing device 50 can accurately control the operation of the image processing device.

In step S705, when the handheld pointing device 50 is powered on, the processing unit 57 reads the static reference voltage W0 of the piezoelectric vibrating gyro element 51 from the memory unit 59.

In step S710, the processing unit 57 receives the first rotation output produced by the piezoelectric vibrating gyro element 51, and the processing unit 57 determines the present rotation value of the present handheld pointing device 50 according to the value resulting from the first rotation output minus the static reference voltage read from the memory unit 59. For example, if the first rotation output is 1.9V and the static reference voltage read from the memory unit 59 is 1V, the present rotation value is 0.9V. Therefore, the processing unit 57 can determine that the handheld pointing device 50 rotates upward along the x axis. That is, the handheld pointing device 50 points upward. If the first rotation output is 0.1V and the static reference voltage read from the memory unit 59 is 1V, the present rotation value is −0.9V. Therefore, the processing unit 57 can determine the handheld pointing device rotates downward along the x axis. That is, the handheld pointing device 50 points downward.

The flow chart in FIG. 7 is adapted for the piezoelectric vibrating gyro element 51 of the handheld pointing device 50. In the embodiment, the flow chart in FIG. 7 is also adapted for the piezoelectric vibrating gyro element 52 of the handheld pointing device 50, and it is not described again for concise purpose.

To sum up, in the embodiment of the invention, the piezoelectric vibrating gyro element is used as a sensor of the handheld pointing device. Therefore, the pointing device is minified to be capable of being held by a hand, and a user may control the cursor on the screen of an image processing device by instinctive gestures. Thus, the user can operate the handheld pointing device in the condition that meets the demand for the ergonomics. Moreover, to ensure the more steady pointing ability of the piezoelectric vibrating gyro element, in the embodiment of the invention, the static reference voltage is updated to solve the problem of static drift.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A handheld pointing device comprising:
a first piezoelectric vibrating gyro element for determining a rotation of the handheld pointing device in a first direction and producing a first rotation output;
a second piezoelectric vibrating gyro element for determining the rotation of the handheld pointing device in a second direction and producing a second rotation output; and
a processing unit, coupled to the first piezoelectric and second vibrating gyro element, for producing a pointing output via the first and second rotation output, wherein when the handheld pointing device is used, the processing unit updates a static reference voltage of the first piezoelectric vibrating gyro element via the first rotation output.

2. The handheld pointing device according to claim 1, wherein the processing unit updates a static reference voltage of the second piezoelectric vibrating gyro element via the second rotation output.

3. The handheld pointing device according to claim 1, wherein the first piezoelectric vibrating gyro element comprises:
a quartz;
a driving circuit, coupled to the quartz, for driving the quartz to vibrate; and
a detecting circuit, coupled to the quartz, for detecting the vibration of the quartz and producing the first rotation output.

4. The handheld direction indicator according to claim 1, wherein the first piezoelectric vibrating gyro element is coupled to a low pass filter, wherein the low pass filter is coupled to an amplifier which is coupled to the processing unit.

5. A pointing method of a handheld pointing device, the method comprising the steps:
determining the rotation of the handheld pointing device in a first direction and a second direction through a piezoelectric vibrating gyro element and producing a first rotation output and a second rotation output;
updating a static reference voltage of the piezoelectric vibrating gyro element in the first direction via the first rotation output; and
producing a pointing output via the first rotation output and the second rotation output.

6. The pointing method according to claim 5, further comprising:
updating a static reference voltage of the piezoelectric vibrating gyro element in the second direction via the second rotation output.

7. The pointing method according to claim 5, wherein the step of updating the static reference voltage further comprises the steps:
calculating a present rotation value of the first rotation output via the first rotation output;
determining whether to update a maximum rotation value and a minimum rotation value according to the present rotation value;
determining whether the handheld pointing device is in a static state; and
if the handheld direction indicator remains in the static state for more than a preset time, using the present rotation value to update the static reference voltage.

8. The pointing method according to claim 7, wherein the static reference voltage stored in a memory unit is updated via the first rotation output.

9. The pointing method according to claim 7, wherein if the present rotation value is greater than the maximum rotation value, the maximum rotation value is updated via the present rotation value.

10. The pointing method according to claim 7, wherein if the rotation value is less than the minimum rotation value, the minimum rotation value is updated via the present rotation value.

11. The pointing method according to claim 7, wherein whether the handheld pointing device is in the static state is determined according to whether the maximum rotation value minus the minimum rotation value leaves a value less than a preset peak to peak value.

12. A method for a handheld pointing device to improve the static drift comprising:
calculating a present rotation value via a rotation output provided by a piezoelectric vibrating gyro element;
determining whether to update a maximum rotation value and a minimum rotation value according to the present rotation value;
determining whether the handheld pointing device is in a static state; and
if the handheld pointing device is in the static state for more than a preset time, updating the static reference voltage of the piezoelectric vibrating gyro element via the present rotation value.

13. The method according to claim 12, wherein the static reference voltage in a memory unit of the handheld pointing device is updated via the first rotation output.

14. The method according to claim 12, wherein if the present rotation value is greater than the maximum rotation value, the maximum rotation value is updated via the present rotation value.

15. The method according to claim 12, wherein if the present rotation value is less than the minimum rotation value, the minimum rotation value is updated via the present rotation value.

16. The method according to claim 12, wherein whether the handheld pointing device is in the static state is determined according to whether the maximum rotation value minus the minimum rotation value leaves a value less than a preset peak to peak value.

17. The method according to claim 12, wherein the static reference voltage of the piezoelectric vibrating gyro element is updated via the following equation:
Wstatic=Wsum/N+Wstatic_org,
wherein, Wstatic stands for a new static reference voltage, Wsum stands for a rotation accumulated value, N stands for a preset count value and Wstatic_org stands for the static reference voltage stored in a memory value of the handheld pointing device.

18. The method according to claim 17, wherein the preset count value stands for the preset time relatively, if the handheld pointing device remains in the static state for a time period counted to be greater than the preset count value, the static reference voltage of the piezoelectric vibrating gyro element is updated.
